(19) United States
(12) Patent Application Publication
(10) Pub. No.: US 2026/0200206 A1
(43) Pub. Date: Jul. 16, 2026

(54) LAMINATED COMPOSITE STRUCTURE

(71) Applicant: Acer Incorporated, New Taipei City (TW)

(72) Inventors: Dong-Sheng Wu, New Taipei City (TW); Wen-Chieh Tai, New Taipei City (TW); Chih-Chun Liu, New Taipei City (TW); Yi-Mu Chang, New Taipei City (TW); Tzu-Wei Lin, New Taipei City (TW); Yu-Shih Wang, New Taipei City (TW)

(73) Assignee: Acer Incorporated, New Taipei City (TW)

(21) Appl. No.: 19/332,002

(22) Filed: Sep. 17, 2025

(30) Foreign Application Priority Data
Jan. 13, 2025 (TW) 114101361

(51) Int. Cl. B32B 5/24; B32B 3/26; B32B 5/12; B32B 5/18

(52) U.S. Cl. CPC B32B 5/245; B32B 3/266; B32B 5/12; B32B 5/18; B32B 2260/021; B32B 2260/046

(57) ABSTRACT

A laminated composite structure including a first prepreg laminate, a second prepreg laminate, a third prepreg laminate, a foam material layer, and a fourth prepreg laminate is provided. The second prepreg laminate is laminated on the first prepreg laminate and has a first hollow opening. The third prepreg laminate is laminated on the second prepreg laminate, wherein the third prepreg laminate has a second hollow opening communicated with the first hollow opening and the second hollow opening is smaller than the first hollow opening. The foam material layer is filled in the first and second hollow openings. The fourth prepreg laminate is laminated on the third prepreg laminate.

### CROSS-REFERENCE TO RELATED APPLICATION

This application claims the priority benefit of Taiwan application serial no. 114101361, filed on January 13, 2025. The entirety of the above-mentioned patent application is hereby incorporated by reference herein and made a part of this specification.

### BACKGROUND

### Technical Field

The disclosure relates to a laminated composite structure, and particularly relates to a laminated composite structure adapted to be applied to a casing of an electronic device.

### Description of Related Art

Currently, casings applied to notebook computers, smartphones, tablet computers, or other electronic devices are usually made of metal, alloy, or a composite material, and since the composite material has characteristics of light weight, high structural strength, durability, etc., it gradually became a mainstream material for manufacturing the casings.

Generally, a process of manufacturing a casing by using the composite material is to first sandwich a foam material layer between two prepreg laminates, and then perform hot pressing molding and cutting in sequence to roughly complete manufacturing of the casing. However, since the foam material layer is exposed at a cutting edge of the casing, which not only affects an aesthetic feeling of appearance, but also increases a risk of external moisture penetrating into the interior. Once the moisture penetrates into the foam material layer, the casing is prone to delamination, resulting in a decrease in structural strength.

### SUMMARY

The disclosure is directed to a laminated composite structure, which may effectively prevent moisture from penetrating into the interior.

The disclosure provides a laminated composite structure including a first prepreg laminate, a second prepreg laminate, a third prepreg laminate, a foam material layer, and a fourth prepreg laminate. The second prepreg laminate is laminated on the first prepreg laminate and has a first hollow opening. The third prepreg laminate is laminated on the second prepreg laminate, wherein the third prepreg laminate has a second hollow opening communicated with the first hollow opening and the second hollow opening is smaller than the first hollow opening. The foam material layer is filled in the first hollow opening and the second hollow opening. The fourth prepreg laminate is laminated on the third prepreg laminate.

Based on the above description, the foam material layer is embedded in the first prepreg laminate, the second prepreg laminate, the third prepreg laminate, and the fourth prepreg laminate, or in other words, the foam material layer is wrapped by the first prepreg laminate, the second prepreg laminate, the third prepreg laminate, and the fourth prepreg laminate to prevent the foam material layer from being exposed at the edge of the laminated composite structure, and block penetration of external moisture into the foam material layer by the tightly bonded first prepreg laminate, second prepreg laminate, third prepreg laminate, and fourth prepreg laminate. Therefore, the laminated composite structure of the disclosure may significantly reduce the problems of delamination and reduction in structural strength caused by expansion of the foam material layer due to moisture.

To make the aforementioned more comprehensible, several embodiments accompanied with drawings are described in detail as follows.

### BRIEF DESCRIPTION OF THE DRAWINGS

FIG. 1A is a schematic exploded view of a composition of a laminated composite structure according to a first embodiment of the disclosure.

FIG. 1B to FIG. 1E are schematic cross-sectional views of a manufacturing process of the laminated composite structure according to the first embodiment of the disclosure.

FIG. 2A is a schematic exploded view of a composition of a laminated composite structure according to a second embodiment of the disclosure.

FIG. 2B is a schematic cross-sectional view of the laminated composite structure according to the second embodiment of the disclosure.

FIG. 3A is a schematic exploded view of a composition of a laminated composite structure according to a third embodiment of the disclosure.

FIG. 3B is a schematic cross-sectional view of the laminated composite structure according to the third embodiment of the disclosure.

FIG. 4 is a schematic cross-sectional view of a laminated composite structure according to a fourth embodiment of the disclosure.

### DESCRIPTION OF THE EMBODIMENTS

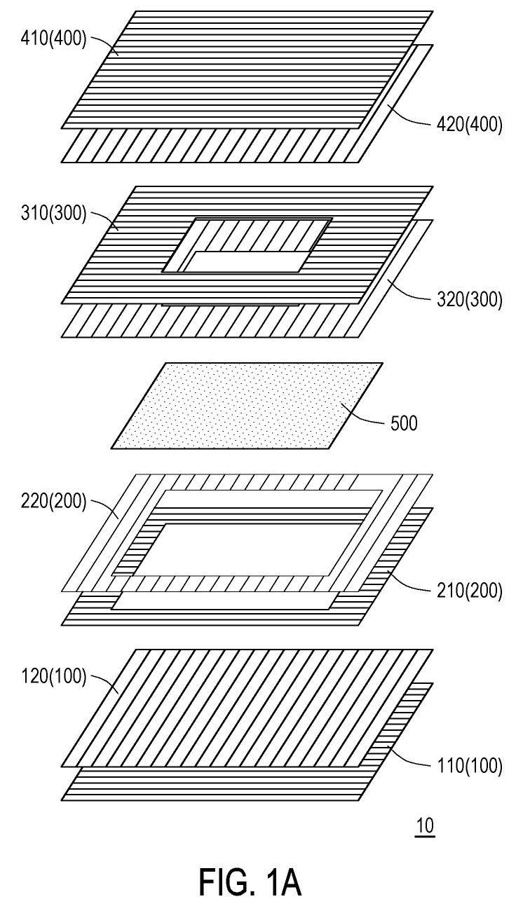

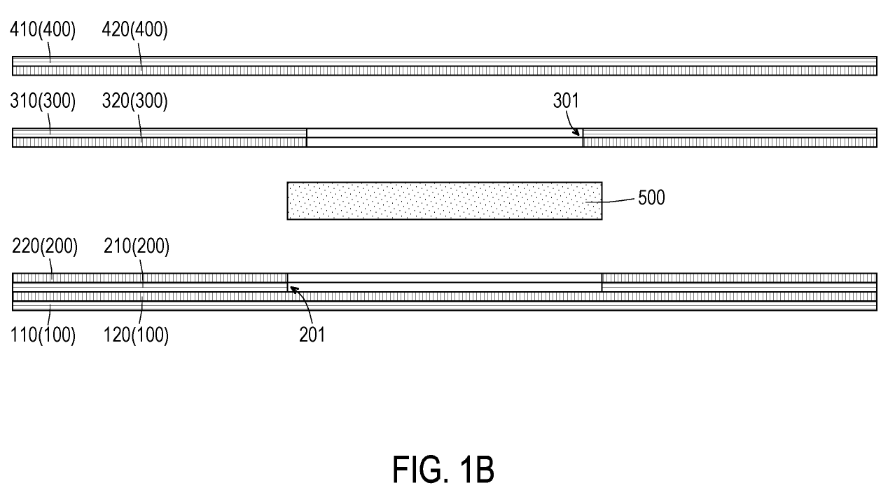

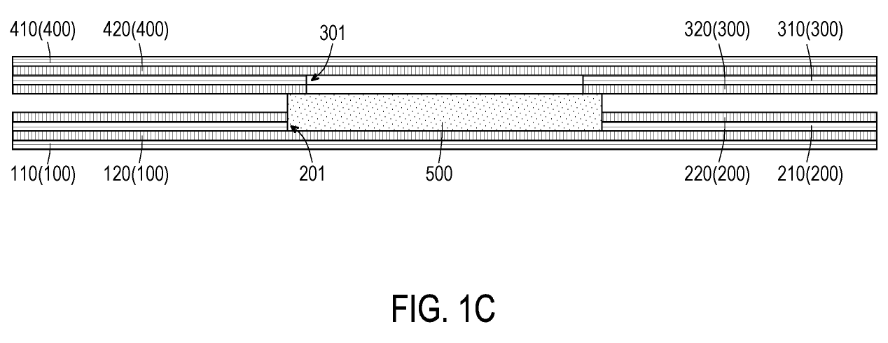

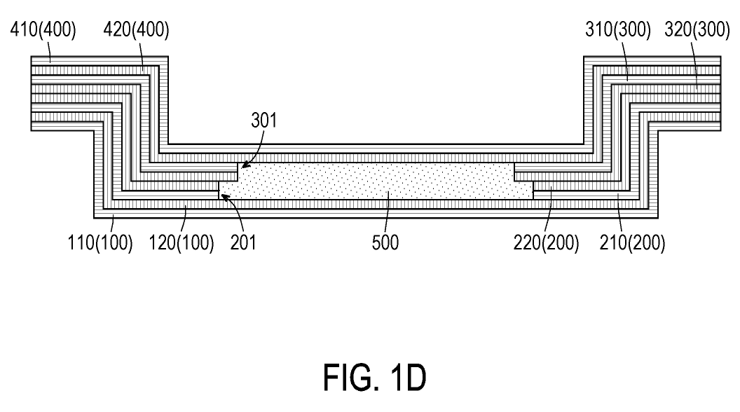

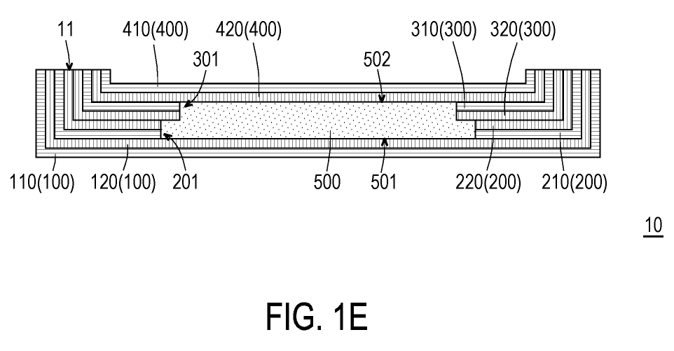

FIG. 1A is a schematic exploded view of a composition of a laminated composite structure according to a first embodiment of the disclosure. FIG. 1B to FIG. 1E are schematic cross-sectional views of a manufacturing process of the laminated composite structure according to the first embodiment of the disclosure. Referring to FIG. 1A, in the embodiment, a laminated composite structure 10 includes a first prepreg laminate 100, a second prepreg laminate 200, a third prepreg laminate 300, a fourth prepreg laminate layer 400, and a foam material layer 500, where the first prepreg laminate 100 and the fourth prepreg laminate 400 serve as surface layers of the laminated composite structure 10, and the second prepreg laminate 200 and the third prepreg laminate 300 serve as core layers of the laminated composite structure 10.

In detail, the second prepreg laminate 200 and the third prepreg laminate 300 are sandwiched between the first prepreg laminate 100 and the fourth prepreg laminate 400, and the foam material layer 500 is sandwiched between the second prepreg laminate 200 and the third prepreg laminate 300. After hot pressing molding, the foam material layer 500 may be embedded in the first prepreg laminate 100, the second prepreg laminate 200, the third prepreg laminate 300, and the fourth prepreg laminate 400, or in other words, the foam material layer 500 is wrapped by the first prepreg laminate 100, the second prepreg laminate 200, the third prepreg laminate 300, and the fourth prepreg laminate 400.

As shown in FIG. 1A and FIG. 1B, the first prepreg laminate 100 includes an outer prepreg 110 and an inner prepreg 120, and the fourth prepreg laminate 400 includes an outer prepreg 410 and an inner prepreg 420. The inner prepreg 120 of the first prepreg laminate 100 is laminated on the outer prepreg 110, and the outer prepreg 410 of the fourth prepreg laminate 400 is laminated on the inner prepreg 420. In addition, the inner prepreg 120 of the first prepreg laminate 100 and the inner prepreg 420 of the fourth prepreg laminate 400 are located between the outer prepreg 110 of the first prepreg laminate 100 and the outer prepreg 410 of the fourth prepreg laminate 400.

On the other hand, the second prepreg laminate 200 includes a first prepreg 210 and a second prepreg 220, and the third prepreg laminate 300 includes a first prepreg 310 and a second prepreg 320. The second prepreg 220 of the second prepreg laminate 200 is laminated on the first prepreg 210, and the first prepreg 210 is located between the inner prepreg 120 and the second prepreg 220. The first prepreg 310 of the third prepreg laminate 300 is laminated on the second prepreg 320, and the first prepreg 310 is located between the inner prepreg 420 and the second prepreg 320.

For example, the foam material layer 500 is made of a low-density polymer foam material, and the above-mentioned each prepreg laminate is a unidirectional prepreg, i.e., a composite material made by pre-impregnating fibers (such as carbon fiber, glass fiber, or aramid fiber) arranged in a single direction and resins (such as epoxy resin).

As shown in FIG. 1A and FIG. 1B, the second prepreg laminate 200 has a first hollow opening 201 that penetrates through the first prepreg 210 and the second prepreg 220. In other words, substrate materials of the first prepreg 210 and the second prepreg 220 are hollow sheets. In addition, the third prepreg laminate 300 has a second hollow opening 301 that penetrates through the first prepreg 310 and the second prepreg 320, or in other words, substrate materials of the first prepreg 310 and the second prepreg 320 are hollow sheets.

As shown in FIG. 1B to FIG. 1E, during a hot pressing molding process, the first prepreg laminate 100 is first placed in a female mold of a mold, and then the second prepreg laminate 200 is laminated on the first prepreg laminate 100, and the first prepreg laminate 100 covers one side of the first hollow opening 201. Then, the foam material layer 500 is placed in the first hollow opening 201, and the foam material layer 500 protrudes from the second prepreg 220 of the second prepreg laminate 200. For example, a size (for example, a length and a width) of the foam material layer 500 is the same as or similar to a size of the first hollow opening 201, and a thickness of the foam material layer 500 is greater than a depth of the first hollow opening 201.

Then, the third prepreg laminate 300 is placed above the second prepreg laminate 200, and the third prepreg laminate 300 contacts the foam material layer 500. Then, the fourth prepreg laminate 400 is laminated on the third prepreg laminate 300, and the fourth prepreg laminate 400 covers one side of the second hollow opening 301. In the embodiment, the second hollow opening 301 is smaller than the first hollow opening 201, or in other words, the first hollow opening 201 is larger than the second hollow opening 301. Namely, a size (such as a length and a width) of the foam material layer 500 is larger than a size of the second hollow opening 301, and before a male mold is clamped to the female mold, the second hollow opening 301 is aligned with the first hollow opening 201, and the foam material layer 500 is not yet filled in the second hollow opening 301.

Then, the male mold is clamped to the female mold, and a step of hot pressing molding is performed on the first prepreg laminate 100, the second prepreg laminate 200, the third prepreg laminate 300, and the fourth prepreg laminate stacked in sequence and the foam material layer 500 sandwiched between the second prepreg laminate 200 and the third prepreg laminate 300, so that the foam material layer 500 is completely filled in the first hollow opening 201 and the second hollow opening 301 communicated with each other. Finally, a mold opening step is performed to take out a rough cut of the laminated composite structure 10, and a remaining material of the rough cut is cut to obtain the laminated composite structure 10.

Referring to FIG. 1E, in the embodiment, the laminated composite structure 10 may be applied to a casing of a notebook computer, a smart phone, a tablet computer, or other electronic devices, and the foam material layer 500 is embedded in the first prepreg laminate 100, the second prepreg laminate 200, the third prepreg laminate 300, and the fourth prepreg laminate 400. In other words, the foam material layer 500 is wrapped by the first prepreg laminate 100, the second prepreg laminate 200, the third prepreg laminate 300, and the fourth prepreg laminate 400 to prevent the foam material layer 500 being exposed at an edge 11 of the laminated composite structure 10, so as to enhance an aesthetic feeling of the overall appearance.

On the other hand, the tightly bonded first prepreg laminate 100, second prepreg laminate 200, third prepreg laminate 300, and fourth prepreg laminate 400 may block external moisture from penetrating into the foam material layer 500 from the edge 11, so that the laminated composite structure 10 may greatly reduce problems of delamination and reduction in structural strength caused by expansion of the foam material layer 500 due to moisture.

In the embodiment, the second prepreg laminate 200 is laminated on the first prepreg laminate 100, and the third prepreg laminate 300 is laminated on the second prepreg laminate 200. In addition, the fourth prepreg laminate 400 is laminated on the third prepreg laminate 300. Further, the outer prepreg 110 of the first prepreg laminate 100, the inner prepreg 120 of the first prepreg laminate 100, the first prepreg 210 of the second prepreg laminate 200, the second prepreg 220 of the second prepreg laminate 200, the second prepreg 320 of the third prepreg laminate 300, the first prepreg 310 of the third prepreg laminate 300, and the inner prepreg 420 of the fourth prepreg laminate 400, and the outer prepreg 410 of the fourth prepreg laminate 400 are stacked in sequence.

Namely, the first prepreg 210 of the second prepreg laminate 200 is located between the inner prepreg 120 of the first prepreg laminate 100 and the second prepreg 220 of the second prepreg laminate 200, and the first prepreg 310 of the third prepreg laminate 300 is located between the inner prepreg 420 of the fourth prepreg laminate 400 and the second prepreg 320 of the third prepreg laminate 300. In addition, the second prepreg 220 of the second prepreg laminate 200 and the second prepreg 320 of the third prepreg laminate 300 are bonded.

As shown in FIG. 1E, the inner prepreg 120 of the first prepreg laminate 100 covers one side of the first hollow opening 201, and the inner prepreg 420 of the fourth prepreg laminate 400 covers one side of second hollow opening 301. In detail, the foam material layer 500 has a first surface 501 and a second surface 502 opposite to the first surface 501. The first surface 501 faces the first prepreg laminate 100 and is in contact with the inner prepreg 120. The second surface 502 faces the fourth prepreg layup 400 and is in contact with the inner prepreg 420. In addition, since the first hollow opening 201 is larger than the second hollow opening 301, an area of the first surface 501 is larger than an area of the second surface 502.

As shown in FIG. 1A and FIG. 1E, a fiber direction of the outer prepreg 110 of the first prepreg laminate 100 is perpendicular to a fiber direction of the inner prepreg 120, and a fiber direction of the outer prepreg 410 of the fourth prepreg laminate 400 is perpendicular to a fiber direction of the inner prepreg 420. In addition, the fiber direction of the outer prepreg 110 of the first prepreg laminate 100 is the same as the fiber direction of the outer prepreg 410 of the fourth prepreg laminate 400, and the fiber direction of the inner prepreg 120 of the first prepreg laminate 100 is the same as the fiber direction of the inner prepreg 420 of the fourth prepreg laminate 400.

A fiber direction of the first prepreg 210 of the second prepreg laminate 200 is perpendicular to a fiber direction of the second prepreg 220, and a fiber direction of the first prepreg 310 of the third prepreg laminate 300 is perpendicular to a fiber direction of the second prepreg 320. In addition, the fiber direction of the first prepreg 210 of the second prepreg laminate 200 is the same as the fiber direction of the first prepreg 310 of the third prepreg laminate 300, and the fiber direction of the second prepreg 220 of the second prepreg laminate 200 is the same as the fiber direction of the second prepreg 320 of the third prepreg laminate 300.

For example, the fiber direction of the outer prepreg 110 of the first prepreg laminate 100, the fiber direction of the first prepreg 210 of the second prepreg laminate 200, the fiber direction of the first prepreg 310 of the third prepreg laminate 300 and the fiber direction of the outer prepreg 410 of the fourth prepreg laminate 400 are all a first fiber direction, for example, a 0-degree direction. In addition, the fiber direction of the inner prepreg 120 of the first prepreg laminate 100, the fiber direction of the second prepreg 220 of the second prepreg laminate 200, the fiber direction of the second prepreg 320 of the third prepreg laminate 300 and the fiber direction of the inner prepreg 420 of the fourth prepreg laminate 400 are all a second fiber direction, for example, a 90-degree direction.

Namely, the fiber direction of the inner prepreg 120 of the first prepreg laminate 100 is perpendicular to the fiber direction of the first prepreg 210 of the second prepreg laminate 200, and the fiber direction of the inner prepreg 420 of the fourth prepreg laminate 400 is perpendicular to the fiber direction of the first prepreg 310 of the third prepreg laminate 300.

As shown in FIG. 1A and FIG. 1E, from the joint between the second prepreg 220 of the second prepreg laminate 200 and the second prepreg 320 of the third prepreg laminate 300 to respectively view outward in two opposite directions, the fiber directions of each layer of the prepreg may be the second fiber direction, the first fiber direction, the second fiber direction, and the first fiber direction in sequence. Such design may effectively improve an anti-bending strength and an anti-shear strength of the laminated composite structure 10.

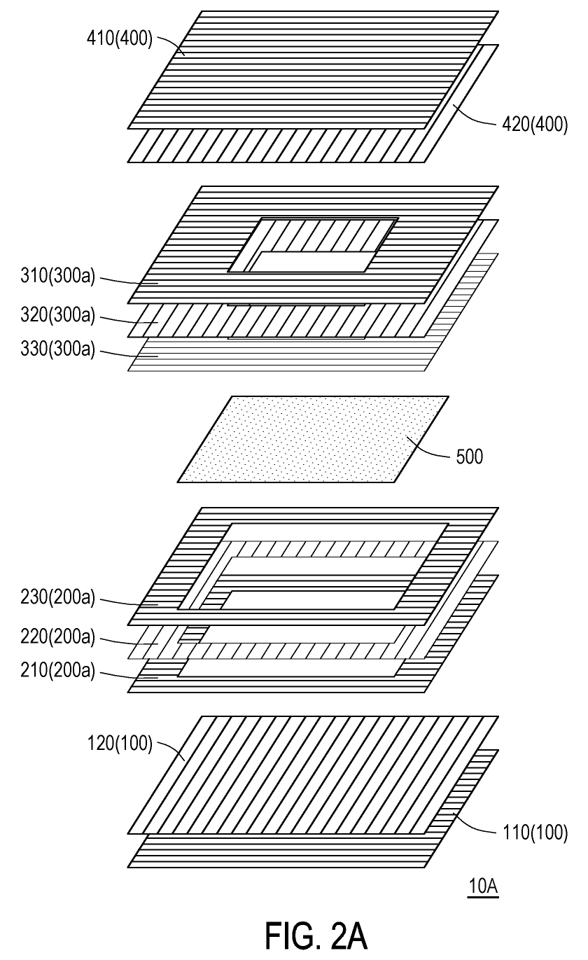

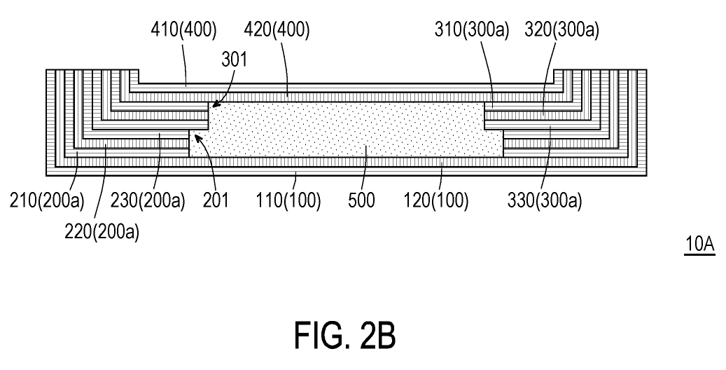

FIG. 2A is a schematic exploded view of a composition of a laminated composite structure according to a second embodiment of the disclosure. FIG. 2B is a schematic cross-sectional view of the laminated composite structure according to the second embodiment of the disclosure. Referring to FIG. 2A and FIG. 2B, a laminated composite structure 10A of the embodiment is substantially the same in design as the laminated composite structure 10 of the first embodiment, and a main difference there between is that: in the embodiment, a second prepreg laminate 200a further includes a third prepreg 230, and a third prepreg laminate 300a further includes a third prepreg 330.

In detail, the second prepreg 220 of the second prepreg laminate 200a is located between the first prepreg 210 and the third prepreg 230, and the second prepreg 320 of the third prepreg laminate 300a is located between the first prepreg 310 and the third prepreg 330. In addition, the third prepreg 230 of the second prepreg laminate 200a is bonded to the third prepreg 330 of the third prepreg laminate 300a, where the first hollow opening 201 further penetrates through the third prepreg 230, and the second hollow opening 301 further penetrates through the third prepreg 330. Namely, substrate materials of the third prepreg 230 of the second prepreg laminate 200a and the third prepreg 330 of the third prepreg laminate 300a are hollow sheets.

As shown in FIG. 2A and FIG. 2B, the fiber direction of the first prepreg 210 of the second prepreg laminate 200a is the same as the fiber direction of the third prepreg 230, which are both the first fiber direction. On the other hand, the fiber direction of the first prepreg 310 of the third prepreg laminate 300a is the same as the fiber direction of the third prepreg 330, which are both the first fiber direction.

From the joint between the third prepreg 230 of the second prepreg laminate 200a and the third prepreg 330 of the third prepreg laminate 300a to respectively view outward in two opposite directions, the fiber directions of each layer of the prepreg may be the first fiber direction, the second fiber direction, the first fiber direction, the second fiber direction, and the first fiber direction in sequence. Such design may effectively improve an anti-bending strength and an anti-shear strength of the laminated composite structure 10A.

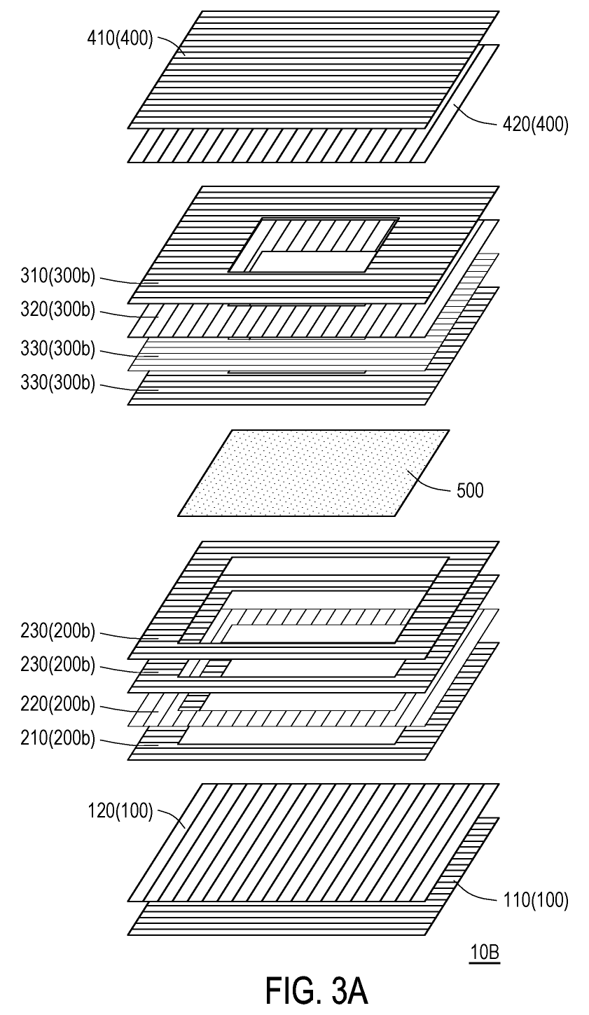

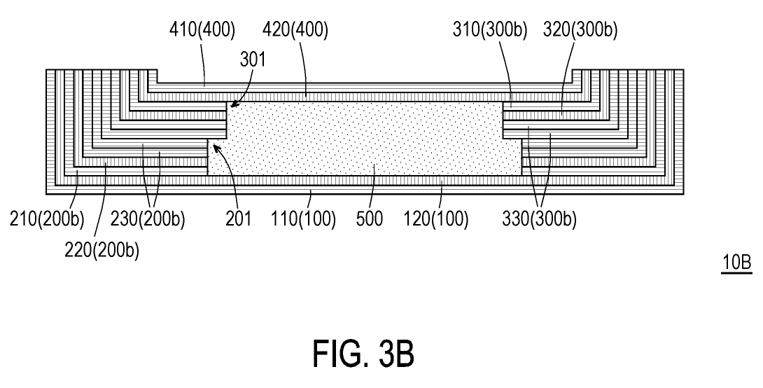

FIG. 3A is a schematic exploded view of a composition of a laminated composite structure according to a third embodiment of the disclosure. FIG. 3B is a schematic cross-sectional view of the laminated composite structure according to the third embodiment of the disclosure. Referring to FIG. 3A and FIG. 3B, a laminated composite structure 10B of the embodiment is substantially the same in design as the laminated composite structure 10A of the second embodiment, and a main difference there between is that: in the embodiment, a number of layers of the third prepreg 230 of the second prepreg laminate 200b is two, and a number of layers of the third prepreg 330 of the third prepreg laminate 300b is two.

From the joint between the innermost third prepreg 230 of the second prepreg laminate 200b and the innermost third prepreg 330 of the third prepreg laminate 300a to respectively view outward in two opposite directions, the fiber directions of each layer of the prepreg may be the first fiber direction, the first fiber direction, the second fiber direction, the first fiber direction, the second fiber direction, and the first fiber direction in sequence. Such design may effectively improve an anti-bending strength and an anti-shear strength of the laminated composite structure 10B.

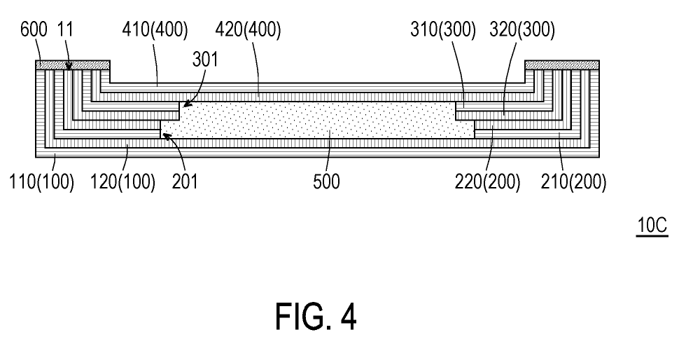

FIG. 4 is a schematic cross-sectional view of a laminated composite structure according to a fourth embodiment of the disclosure. Referring to FIG. 4, a laminated composite structure 10C of the embodiment is substantially the same in design as the laminated composite structure 10 of the first embodiment, and a main difference there between is that: in the embodiment, the laminated composite structure 10C further includes a barrier layer 600, which is formed of, for example, silicone or other waterproof colloids.

In detail, edges of each layer of the prepregs in the first prepreg laminate 100, the second prepreg laminate 200, the third prepreg laminate 300 and the fourth prepreg laminate 400 are aligned with each other to form an edge 11, and the barrier layer 600 covers the edge 11 to prevent external moisture from penetrating into the foam material layer 500 from the joint between any two adjacent layers of prepregs.

In summary, the foam material layer is embedded in the first prepreg laminate, the second prepreg laminate, the third prepreg laminate, and the fourth prepreg laminate, or in other words, the foam material layer is wrapped by the first prepreg laminate, the second prepreg laminate, the third prepreg laminate, and the fourth prepreg laminate to prevent the foam material layer from being exposed at the edge of the laminated composite structure, and block penetration of external moisture into the foam material layer by the tightly bonded first prepreg laminate, second prepreg laminate, third prepreg laminate, and fourth prepreg laminate. Therefore, the laminated composite structure of the disclosure may significantly reduce the problems of delamination and reduction in structural strength caused by expansion of the foam material layer due to moisture.

On the other hand, the first prepreg laminate and the fourth prepreg laminate serve as the surface layers of the laminated composite structure, while the second prepreg laminate and the third prepreg laminate serve as the core layers of the laminated composite structure. In detail, the first prepreg laminate, the second prepreg laminate, the third prepreg laminate, and the fourth prepreg laminate are all formed by laminating multiple layers of unidirectional prepregs and each contains at least two layers of unidirectional prepregs with fiber directions perpendicular to each other, so as to effectively improve the anti-bending strength and anti-shear strength of the laminated composite structure.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A laminated composite structure, comprising:
a first prepreg laminate;
a second prepreg laminate, laminated on the first prepreg laminate, and having a first hollow opening;
a third prepreg laminate, laminated on the second prepreg laminate, wherein the third prepreg laminate has a second hollow opening communicated with the first hollow opening, and the second hollow opening is smaller than the first hollow opening;
a foam material layer, filled in the first hollow opening and the second hollow opening; and
a fourth prepreg laminate, laminated on the third prepreg laminate.

2. The laminated composite structure as claimed in claim 1, wherein the foam material layer has a first surface and a second surface opposite to the first surface, the first surface faces the first prepreg laminate and contacts the first prepreg laminate covering the first hollow opening, and the second surface faces the fourth prepreg laminate, and contacts the fourth prepreg laminate covering the second hollow opening.

3. The laminated composite structure as claimed in claim 2, wherein an area of the first surface of the foam material layer is greater than an area of the second surface.

4. The laminated composite structure as claimed in claim 1, wherein the first prepreg laminate and the fourth prepreg laminate both comprise an outer prepreg and an inner prepreg, the inner prepreg of the first prepreg laminate and the inner prepreg of the fourth prepreg laminate respectively cover the first hollow opening and the second hollow opening, and respectively contact two opposite surfaces of the foam material layer.

5. The laminated composite structure as claimed in claim 4, wherein a fiber direction of the outer prepreg of the first prepreg laminate is perpendicular to a fiber direction of the inner prepreg of the first prepreg laminate, and a fiber direction of the outer prepreg of the fourth prepreg laminate is perpendicular to a fiber direction of the inner prepreg of the fourth prepreg laminate.

6. The laminated composite structure as claimed in claim 5, wherein the fiber direction of the outer prepreg of the first prepreg laminate is the same as the fiber direction of the outer prepreg of the fourth prepreg laminate, and the fiber direction of the inner prepreg of the first prepreg laminate is the same as the fiber direction of the inner prepreg of the fourth prepreg laminate.

7. The laminated composite structure as claimed in claim 4, wherein the second prepreg laminate and the third prepreg laminate both comprise a first prepreg and a second prepreg, the first prepreg of the second prepreg laminate is located between the inner prepreg of the first prepreg laminate and the second prepreg of the second prepreg laminate, and the first prepreg of the third prepreg laminate is located between the inner prepreg of the fourth prepreg laminate and the second prepreg of the third prepreg laminate.

8. The laminated composite structure as claimed in claim 7, wherein the second prepreg of the second prepreg laminate is bonded to the second prepreg of the third prepreg laminate, the first hollow opening penetrates through the first prepreg and the second prepreg of the second prepreg laminate, and the second hollow opening penetrates through the first prepreg and the second prepreg of the third prepreg laminate.

9. The laminated composite structure as claimed in claim 7, wherein a fiber direction of the first prepreg of the second prepreg laminate is perpendicular to a fiber direction of the second prepreg of the second prepreg laminate, and a fiber direction of the first prepreg of the third prepreg laminate is perpendicular to a fiber direction of the second prepreg of the third prepreg laminate.

10. The laminated composite structure as claimed in claim 9, wherein the fiber direction of the first prepreg of the second prepreg laminate is the same as the fiber direction of the first prepreg of the third prepreg laminate, and the fiber direction of the second prepreg of the second prepreg laminate is the same as the fiber direction of the second prepreg of the third prepreg laminate.

11. The laminated composite structure as claimed in claim 7, wherein a fiber direction of the inner prepreg of the first prepreg laminate is perpendicular to a fiber direction of the first prepreg of the second prepreg laminate, and a fiber direction of the inner prepreg of the fourth prepreg laminate is perpendicular to a fiber direction of the first prepreg of the third prepreg laminate.

12. The laminated composite structure as claimed in claim 7, wherein the second prepreg laminate and the third prepreg laminate both comprise at least one third prepreg, the second prepreg of the second prepreg laminate is located between the first prepreg of the second prepreg laminate and the at least one third prepreg of the second prepreg laminate, and the second prepreg of the third prepreg laminate is located between the first prepreg of the third prepreg laminate and the at least one third prepreg of the third prepreg laminate.

13. The laminated composite structure as claimed in claim 12, wherein the at least one third prepreg of the second prepreg laminate is bonded to the at least one third prepreg of the third prepreg laminate, the first hollow opening penetrates through the first prepreg, the second prepreg, and the at least one third prepreg of the second prepreg laminate, and the second hollow opening penetrates through the first prepreg, the second prepreg, and the at least one third prepreg of the third prepreg laminate.

14. The laminated composite structure as claimed in claim 12, wherein a fiber direction of the first prepreg of the second prepreg laminate is the same as a fiber direction of the at least one third prepreg of the second prepreg laminate, and is perpendicular to a fiber direction of the second prepreg of the second prepreg laminate, and a fiber direction of the first prepreg of the third prepreg laminate is the same as a fiber direction of the at least one third prepreg of the third prepreg laminate, and is perpendicular to a fiber direction of the second prepreg of the third prepreg laminate.

15. The laminated composite structure as claimed in claim 14, wherein the fiber direction of the first prepreg of the second prepreg laminate, the fiber direction of the at least one third prepreg of the second prepreg laminate, the fiber direction of the first prepreg of the third prepreg laminate, and the fiber direction of the at least one third prepreg of the third prepreg laminate are the same, and the fiber direction of the second prepreg of the second prepreg laminate is the same as the fiber direction of the second prepreg of the third prepreg laminate.

16. The laminated composite structure as claimed in claim 12, wherein a fiber direction of the inner prepreg of the first prepreg laminate is perpendicular to a fiber direction of the first prepreg of the second prepreg laminate, and a fiber direction of the inner prepreg of the fourth prepreg laminate is perpendicular to a fiber direction of the first prepreg of the third prepreg laminate.

17. The laminated composite structure as claimed in claim 1, further comprising:
a barrier layer, covering edges of the first prepreg laminate, the second prepreg laminate, the third prepreg laminate, and the fourth prepreg laminate.
